(19) United States
(12) Patent Application Publication
(10) Pub. No.: US 2010/0270181 A1
(43) Pub. Date: Oct. 28, 2010

(54) Advertising/Promotional product and holding system

(76) Inventor: Elizabeth Morgan, Lyme, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/799,111

(22) Filed: Apr. 19, 2010

Related U.S. Application Data
(60) Provisional application No. 61/214,404, filed on Apr. 23, 2009.

(51) Int. Cl. B65D 51/00; B65D 85/00; B42D 15/00; A45C 11/18; B65D 25/54

(52) U.S. Cl. 206/45.29; 206/459.5; 283/56; 206/39; 206/769

(57) ABSTRACT

By providing a pre-printed promotional holding system which can be produced in a wide variety of alternate forms and/or configurations and which employs a pre-folded, fully assembled panel system which is quickly and easily converted from a substantially flat configuration into a three-dimensional, fully constructed configuration, a hands-on, printed, visually exciting and interest generating advertising/promotional product and holding system is attained. This previously unattainable result is realized in the present invention. In the preferred embodiment, the panel system automatically produces, when moved into its three-dimensional configuration, a fully enclosed, rectangular shaped box incorporating an arcuately pivotable cover plate preferably associated with the top surface of the box. This unique, automatic box-forming construction is achieved by employing a single sheet of material formed and cut to effectively create two, cooperating, rectangular shaped, four sided, foldable panel assemblies, which are interconnected with each other and constructed in a fully integrated, cooperating relationship.

### RELATED DATA

This application is related to U.S. Provisional Patent Application Ser. No. 61/214,404, filed Apr. 23, 2009 entitled ADVERTISING/PROMOTIONAL PRODUCT AND HOLDING SYSTEM.

### TECHNICAL FIELD

This invention relates to advertising/promotional display and holding systems and, more particularly, to advertising/promotional display and holding systems for providing visually exciting and interest generating products and delivery systems.

### BACKGROUND ART

With the ever-increasing quantity of products and services being offered to consumers, substantial interest has been given to promotional systems for advertising such products and services and for presenting gifts or awards to consumers or customers in a unique manner. In this regard, a wide variety of advertising displays and promotional literature has been created and distributed to consumers. However, due to the deluge of material to which average consumers are constantly exposed, greater emphasis has been placed on developing eye-catching visual displays, promotional material, and delivery systems which stand out as being visually unique in order to receive consumer attention.

Although various novelty products, printed displays, and delivery systems have been created in an attempt to satisfy this demand, these prior art products have failed to provide the desired interest generating result with production costs which advertisers are capable of justifying. In attempting to generate a unique advertising display and delivery system, some prior art products have employed complex folding systems which produce a three-dimensional display when activated or unfolded.

In spite of the unique visual appearance generated by such products, the overall cost of production and complexity of the assembly of these systems has prevented such prior art systems from becoming popular. In particular, many prior art systems require multi-part segments to be aligned or placed in specific registered positions or locations. This requirement is both time consuming and costly.

Other prior art displays have attempted to generate consumer interest by providing unique visual images or other indicia as an integral part of the display or delivery system. However, these prior art attempts have also failed to generate the consumer interest being sought, largely due to an inability to physically involve the consumer in the promotion or display operation.

Furthermore, the ever increasing consumer demand seeks to obtain promotional products or delivery systems which produce unique and/or surprising results. In this regard, consumers are continuously seeking products which will produce a surprising visual effect when used, while also providing a useful and desirable function.

Therefore, it is a principal object of the present invention to provide a printed advertising and holding system which is capable of being produced at a reasonable cost and provides an exciting, interest generating display, while also enabling a desired gift or product to be retained therewith.

Another object of the present invention is to provide a printed advertising or promotional product having the characteristic features described above, which enables the consumer to physically control the presentation of the display in a unique, hands-on manner.

Another object of the present invention is to provide a printed advertising or promotional product and holding system having the characteristic features described above, which is capable of mass production and assembly.

Another object of the present invention is to provide a printed advertising or promotional product and holding system having the characteristic features described above, which is completely produced and assembled without requiring special segment alignment or registration.

A further object in the present invention is to provide a printed advertising or promotional product and holding system having the characteristic features described above, which provides a unique, eye-catching, exciting and surprising visual change which is produced in response to action taken by the consumer.

Another object of the present invention is to provide a printed advertising or promotional product and holding system having the characteristic features described above, which provides an eye-catching visual display which is usable as a gift holding member for being presented to another individual.

Other and more specific objects will in part be obvious and will in part appear hereinafter.

### SUMMARY OF THE INVENTION

By employing the present invention, all of the difficulties and inabilities of the prior art are eliminated and a unique, hands-on, printed, visually exciting and interest generating advertising/promotional product and holding system is attained. This desirable and previously unattainable result is realized in the present invention by providing a unique, pre-printed promotional holding system which can be produced in a wide variety of alternate forms and/or configurations. However, regardless of the printed form or configuration desired, the promotional holding system of the present invention employs a pre-folded, fully assembled panel system which is quickly and easily converted from a substantially flat configuration into a three-dimensional, fully constructed configuration.

In the preferred embodiment, the panel system automatically produces, when moved into its three-dimensional configuration, a fully enclosed, rectangular shaped box incorporating an arcuately pivotable cover plate preferably associated with the top surface of the box. This unique, automatic box-forming construction is achieved by employing in the preferred embodiment, a single sheet of material which has been formed and cut to effectively create two, cooperating, rectangular shaped, four sided, foldable panel assemblies, which are interconnected with each other and constructed in a fully integrated, cooperating relationship. In addition, although each of the two foldable panel assemblies are hollow in cross-section and form a rectangular shaped element closed on four sides, by mounting the two cooperating panel assemblies at right angles to each other and having both assemblies share a common panel member, a fully constructed, rectangularly shaped box is achieved quickly and easily, with the box being closed on all six sides.

In order to move the advertising/promotional product and holding system of the present invention from its first, substantially flat configuration into its second, fully erect, three-dimensional configuration, the two independent panel assemblies are activated. Typically, each panel assembly is separately activated by the imposition of a force perpendicular to one side surface thereof. This activation force effectively causes the panel assembly to move from its first, flat configuration into its second, fully erect, three-dimensional configuration.

In accordance with the present invention; although two separate panel assemblies are employed and are separately activated, the fact that each panel assembly share one common panel member as one common element of each panel assembly, the activation of the two panel assemblies causes a single, rectangularly shaped box to be achieved. In this way, the uniquely constructed visually exciting and interest generating advertising/promotional product and holding system of the present invention is capable of being quickly and easily constructed for use and/or presentation.

In accordance with the present invention, the adverting/promotional product and holding system is employed for a wide variety of alternate purposes, as well as in a wide variety of alternate configurations and constructions. In this regard, by incorporating preprinted information, designs, colors, logos, or other indicia on the surfaces of the advertising/promotional product and holding system, an exciting and interest generating result is achieved which can be implemented for achieving any desired promotion or visual impact. In this way, any information, message, or graphic display desired by a sponsor or consumer of the promotional system is easily conveyed in a attractive, exciting, and interest generating manner.

Furthermore, the advertising/promotional product and holding system of the present invention may be constructed with apertures preformed in any panel member for enabling the rectangular shaped box to be employed as a gift holding box. As a result, by constructing the size of the box for enabling a desired sized gift to be retained therein, a gift box is quickly and easily assembled with the desired gift placed therein for presentation to a recipient. In addition to receiving a gift retained in the box, any desired graphics, indicia, and the like can be printed on the surface of the box in order to further enhance the excitement and interest generated by the promotional product and holding system of the present invention.

In one preferred embodiment of the present invention, the advertising/promotional product and holding system is constructed for retaining substantially flat elements, products, or panels, such as gift cards, credit cards, money cards, debit cards, lottery cards, prize cards, show tickets, theater tickets, prize awards, and the like, hereinafter referred to both separately and inclusively as a “gift card”. In this way, in this one particular use, a consumer is able to purchase a gift card for presentation to any desired individual, and provide that gift card to the recipient in a fully erect, fully constructed “gift box”.

By quickly and easily constructing the advertising/promotional product and holding system of the present invention by converting the holding system from its first, substantially flat configuration into its second, three-dimensional configuration, the purchaser is able to place the gift card on the top panel of the preformed box, in a holding zone provided thereon. Then, the pivotal cover plate associated with the top surface is placed in overlying engagement with the gift card. In this way, the gift card is sandwiched between the top surface of the preformed box and the pivotal cover plate.

By constructing the holding system of the present invention with decorative surface indicia pre-printed on all exposed surfaces, an attractive, exciting, and interest generating gift construction is realized which is capable of securely holding various products, such as gift cards in a manner which provides an exciting and interest generating display for the recipient. In addition, the gift card holding system of the present invention also enables individuals to provide a unique, attractive, and excitement-generating gift to any recipient in a manner which enhances the significance of the gift and the presentation of the gift.

The invention of accordingly comprises an article of manufacture possessing the features, properties, and relation of the elements which will be exemplified in the article hereinafter described, and the scope of the invention will be indicated in the claims.

### THE DRAWINGS

For a fuller understanding of the nature and objects of the present invention, reference should be had to the following detailed description taken in connection with the accompanying drawings, in which:

FIG. 1 is a perspective view of the advertising/promotional display and holding system of the present invention depicted shown in its fully constructed, fully erect three-dimensional configuration, shown retaining a card member therewith and with its pivotable cover plate in the raised position;

FIG. 2 is a perspective view of the advertising/promotional display and holding system of FIG. 1 shown with its pivotable cover plate in the closed position;

FIG. 3 is a substantially flat, planar view of the adverting/promotional display and holding system of FIG. 1 shown completely unassembled;

FIGS. 4-11 are perspective views of the advertising/promotional display and holding system of FIG. 1 shown in various stages of formation; and

FIG. 12 is a top plan view of the substantially flat panel configuration employed for forming the advertising/promotional display and holding system of FIG. 1.

### DETAILED DESCRIPTION

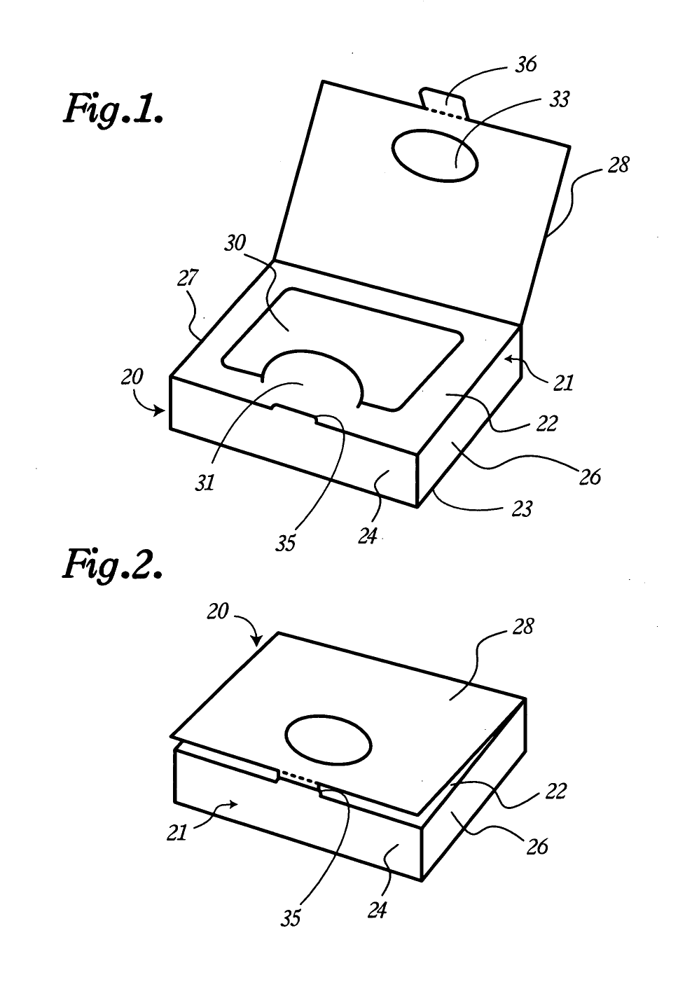

By referring to FIGS. 1-12, along with the following detailed discussion, the construction and operation of one preferred embodiment of advertising or promotional product and holding system 20 of the present invention can best be understood. However, additional constructions and variations can be made in this embodiment without departing from the scope of the present invention. Consequently, it is to be understood that the present invention encompasses all such variations of construction and the preferred embodiment herein is provided for exemplary purposes only and is not intended as a limitation of the present invention.

In FIGS. 1 and 2, the preferred embodiment of advertising/promotional product and holding system 20 of the present invention is depicted in its second, fully assembled, three-dimensional configuration. As shown, advertising/promotional product and holding system 20 comprises a substantially rectangular shaped housing 21 which incorporates top panel 22, bottom panel 23, front wall 24, rear wall 25, and side walls 26 and 27. In addition, in the preferred construction, advertising/promotional product and holding system 20 incorporates pivotable cover plate or panel 28 which is mounted to top surface 22 along one edge of panel 28 in a manner which enables cover plate/panel 28 to be arcuately pivotable from a first, fully raised position, as shown in FIG. 1 into a second, overlying, surface covering position, as shown in FIG. 2. In this second, surface covering position, panel 28 effectively overlies and substantially covers the top surface of panel 22.

As detailed in this disclosure, advertising/promotional product and holding system 20 is capable of being employed for a wide variety of various products and end uses. As depicted in FIGS. 1 and 2, one preferred embodiment for advertising/promotional product and holding system 20 is its use as a gift holding box and/or presentation box for a substantially flat card member 30, such as a gift card, calling card, credit card, membership card, lottery card, theater tickets, and the like.

As shown in FIG. 1, top panel 22 preferably incorporates a flap or cutaway portion 31 which is constructed for enabling card member 30 to be quickly and easily inserted therewith and securely held on top panel 22 in a precisely desired position and/or location. In addition, cutaway portion 31 also incorporates an enlarged area or zone for enabling an appropriate message to be printed or written thereon for the recipient. If desired, pivotal panel 28 may also incorporate an aperture 33 form therein which is aligned with holding flap 31 for enabling the message printed on flap 31 to be viewed through panel 28, even when panel 28 is in its second, overlying top surface covering position.

Finally, as depicted in FIGS. 1 and 2, top panel 22 of housing 21 preferably incorporates slot 35 formed substantially midway along the juncture between top panel 22 and front wall 24. In addition, panel 28 also incorporates tab 36 extending from the free edge thereof, with tab 36 being positioned and constructed for insertion into slot 35 of housing 21. In this way, whenever panel 28 is pivoted into its second, closed, surface overlying position, this position can be easily retained by inserting tab 36 into slot 35. If desired, fastening means can be employed to assure the securement of cover plate 28 with top panel 22, thereby securely retaining card member 30 in the desired position, until cover plate 28 has been opened by the recipient.

In order to produce advertising/promotional product and holding system 20 of the present invention in a highly efficient and economical manner, product/holding system 20 is preferably constructed from a single flat sheet of material which is pre-cut into a predetermined configuration. The preferred configuration employed in achieving product/holding system 20 of the present invention is fully depicted in FIGS. 1 and 2.

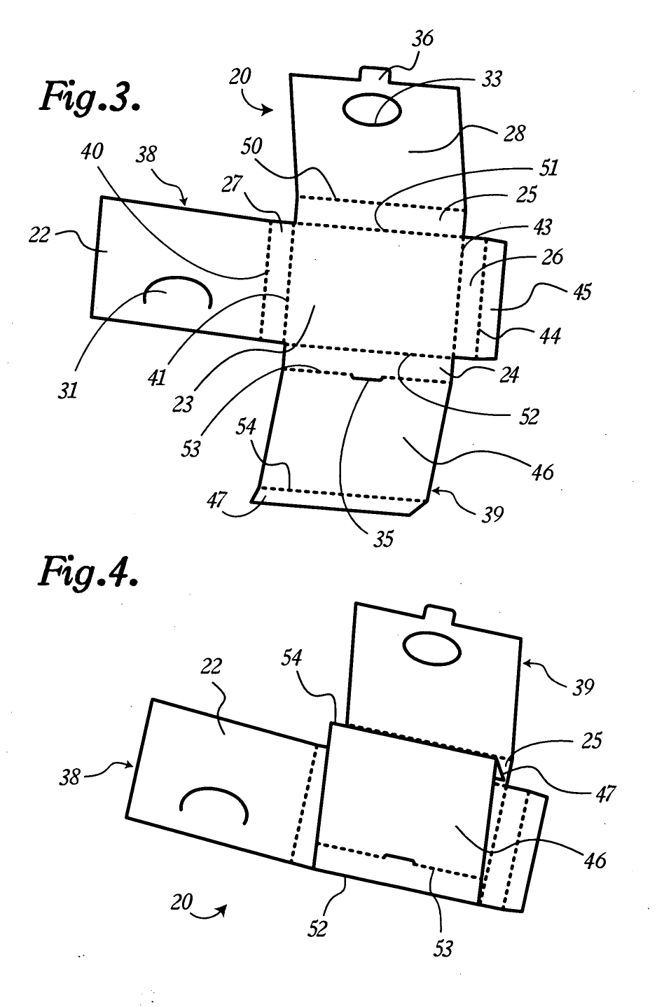

Once the desired, pre-cut, substantially flat sheet of material is attained, the sheet is folded along specific fold lines in order to achieve the desired product. By referring to FIGS. 3-6 along with the following detailed disclosure, the overall construction and folding arrangement for achieving product/holding system 20 of the present invention can best be understood. In addition, although the preferred folding method is depicted in FIGS. 3-6 and detailed below, it should be understood that variations and alterations in this folding sequence can be made without departing from the scope of this invention, with all such variations and alterations being included in the present invention.

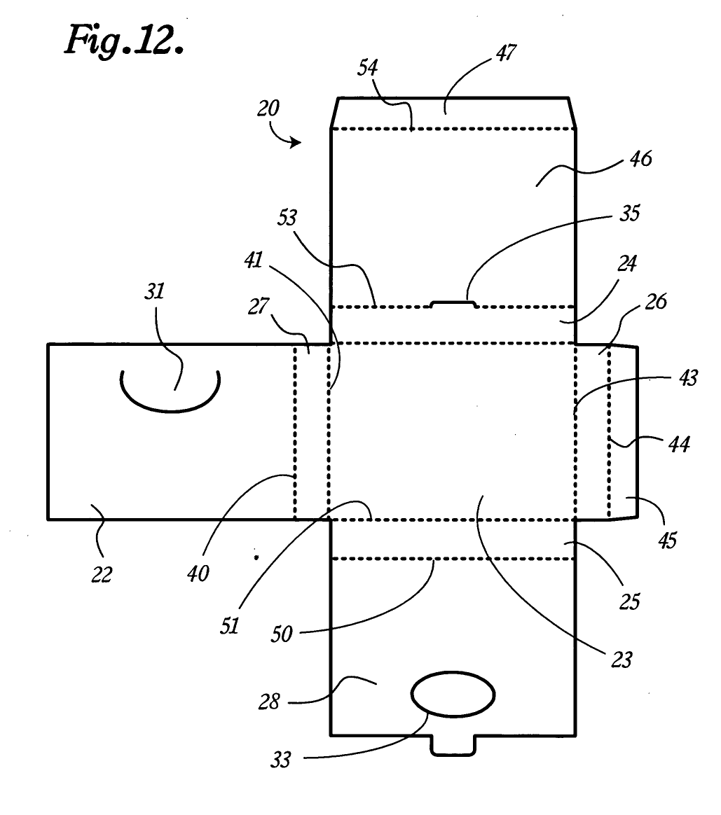

As shown in FIGS. 3 and 12, each of the panels forming housing 21 and product/holding system 20 are depicted with fold lines being formed between panels which are adjacent to each other. In this regard, in the preferred construction of this embodiment of the present invention, top panel 22 is adjacent side wall 27 with fold line 40 formed therebetween. In addition, bottom panel 23 is positioned adjacent to side wall 27 with fold line 41 formed therebetween. Furthermore, bottom panel 23 is also adjacent to side wall 26 with fold line 43 formed therebetween, while side wall 26 is adjacent to construction strip 45, with fold line 44 formed therebetween.

As discussed above, housing 21 is formed by two separate panel assemblies which share one common panel member. In FIG. 3, separate panel assemblies 38 and 39 are fully depicted. As shown therein, panel assemblies 38 incorporate top panel 22, side wall 27, bottom panel 23, side wall 26, and construction strip 45. In addition, panel assemblies 39 incorporate cover plate 28, rear wall 25, bottom panel 23, front wall 24, interior panel 46, and construction strip 45.

In addition, panel assembly 39 also incorporates fold line 50 formed between cover plate 28 and rear wall 25, fold line 51 formed between rear wall 25 and bottom panel 23, fold line 52 formed between front wall 24 and bottom panel 23, fold line 53 formed between front wall 24 and interior panel 46 and fold line 54 formed between interior panel 46 and construction strip 47. Finally, as discussed above, slot 35 is formed in fold line 53 substantially midway along the length thereof.

By employing this construction, advertising/promotional display and holding system 20 is quickly and easily assembled. As best seen in FIG. 4, the first step in the assembly of the advertising/promotional display and holding system 20 is the construction of panel assembly 39. This assembly is preferably achieved by first folding construction strip 47 about fold line 54 toward the inside surface of interior panel 46. Then, interior panel 46 is folded about fold line 54 in order to bring construction strip 47 into overlying alignment with rear wall 25. Preferably, prior to initiating the folding operation, adhesive means, such as glue, is positioned along the interior surface of rear wall 25. In this way, once construction strip 47 is placed in contact with the inside surface of the rear wall 25, construction strip 47 is securely affixed thereto, and panel assembly 39 is completed.

The second step in fully assembling advertising/promotional display and holding system 20 is the assembly of panel assembly 38. In this regard, as is shown in FIG. 5, panel assembly 38 is completed by applying adhesive means to the outer surface of construction strip 45 and folding construction strip 45 about fold line 44 into contact with side wall 26. Thereafter, top panel 22 and side edge 27 are folded about fold line of 44 with the inside surface of top panel 22 being placed into secure engagement with the adhesive means placed on construction strip 45. Once top panel 22 is placed in contact with the adhesive surface of construction strip 45, panel 22 is affixed thereto and panel assembly 38 is completed.

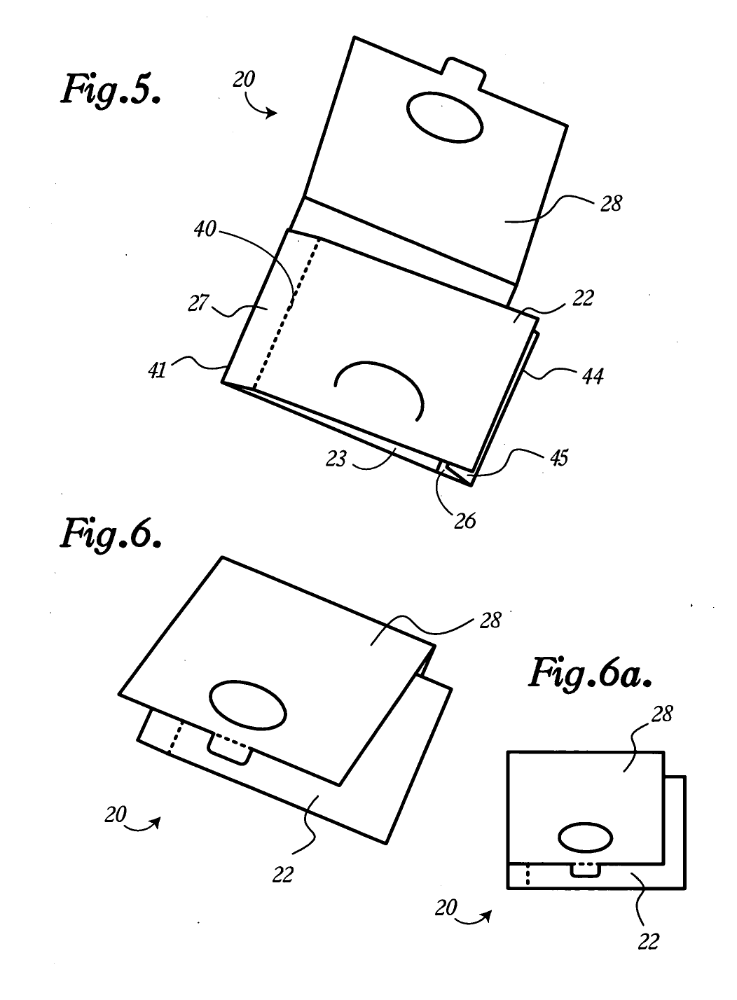

As shown in FIGS. 6 and 6A, the last step in completely assembling advertising/promotional display and holding system 20 of the present invention is the arcuate pivoting movement of cover plate 28 about fold line 50, bringing cover plate 28 into contact with top surface 22. Once this position has been achieved, advertising/promotional display and holding system 20 is fully assembled and securely positioned in its first, two-dimensional, folded configuration.

Once advertising/promotional display and holding system 20 is fully assembled and positioned in its first, substantially flat, two-dimensional configuration, holding system 20 is ready for shipment to any desired company, individual, and/or retail outlet. By maintaining holding system 20 in the flat, folded configuration, ease of shipment and distribution is achieved, as well as ease of display for purchase.

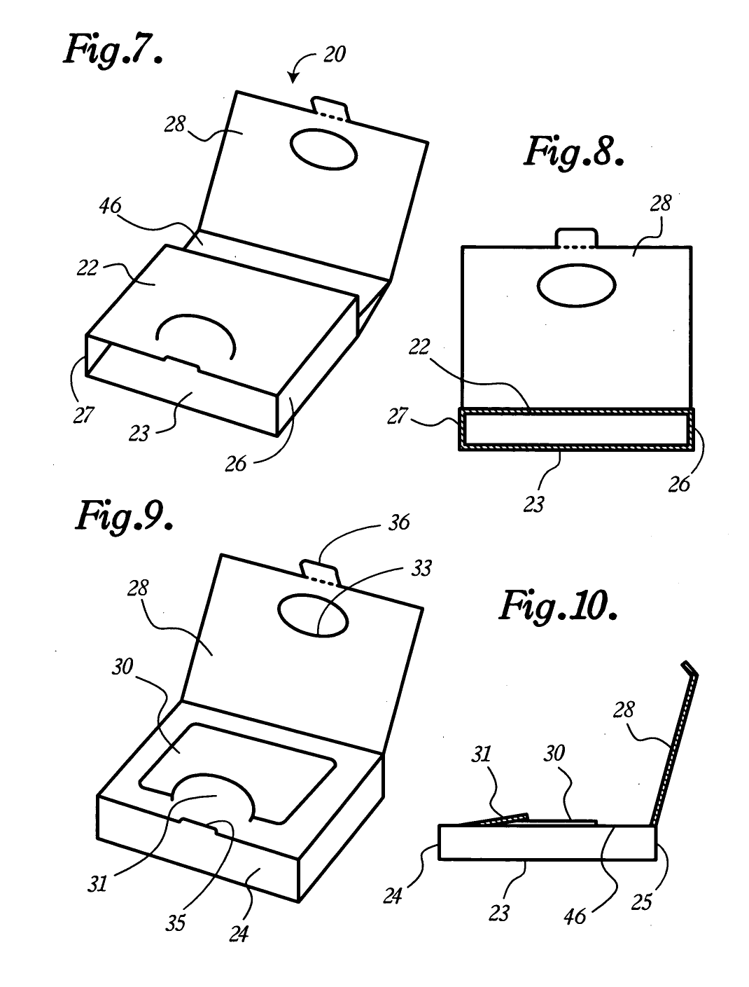

Whenever advertising/promotional display and holding system 20 of the present invention is to be used for any desired purpose, holding system 20 is transformed from its first, substantially flat, two-dimensional configuration into its second, fully assembled, three-dimensional configuration. By referring to FIGS. 7-11, along with the following detailed description, the assembly and use of the advertising/promotional display and holding system 20 can best be understood.

In the preferred embodiment, the first step in transforming holding system 20 from its two-dimensional configuration into his three-dimensional configuration is to arcuately pivot plate 28 away from top panel 22. Thereafter, forces are applied to the opposed side walls of housing 21, substantially perpendicularly to side walls 26 and 27 in order to cause side wall 26 to arcuately pivot about fold line 43, while side wall 27 arcuately pivots about fold line 41. Simultaneously therewith, construction strip 45 and top panel 22 arcuately pivots about fold line 44, while the opposite edge of top panel 22 arcuately pivots about fold line 41. Once completed, substantially rectangular shaped panel assembly 38 is achieved which is defined by top panel 22, side wall 27, bottom panel 23, and side wall 26, with the interior thereof being substantially empty.

In the next step, panel assembly 39 is transformed from its substantially flat, two-dimensional configuration into its fully erect, three-dimensional configuration. In order to achieve this transformation, opposed forces are applied to front wall 24 and rear wall 25, causing front wall 24 to arcuately pivot about fold line 52, while rear wall 25 and construction strip 47 arcuately pivot about fold line 51. Simultaneously therewith, interior panel 46 arcuately pivots about fold line 54 on one edge thereof and fold line 53 along the opposed edge thereof. Once completed, substantially rectangular shaped panel assembly 39 is formed, defined by interior panel 46, front wall 24, bottom panel 23, and rear wall 25. In addition, panel assembly 39 is formed within panel assembly 38, effectively completing the formation of housing 21, with housing 21 being closed on all sides thereof.

Once advertising/promotional display and holding system 20 is fully formed in its second, fully erect, three-dimensional configuration, holding system 20 is ready for use in any desired manner. As depicted in FIGS. 9 and 10, one preferred use of holding system 20 is to securely retain card member 30 for presentation to another individual as a gift, prize, award, or the like.

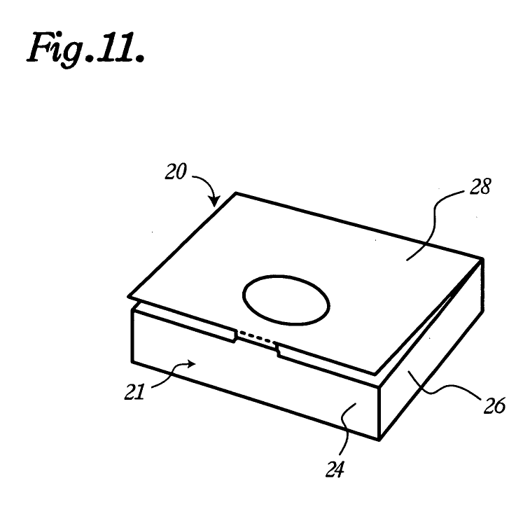

In order to achieve this result, card member 30 is quickly and easily positioned in the desired location in association with flap or cutaway portion 31, retaining card member 30 in the precisely desired location. Thereafter, cover plate 28 is arcuately pivoted into overlying covering relationship with card member 30, while tab 36 is inserted into slot 35 for retaining card member 30 in its secured position, while also being obscured from view, as shown in FIG. 11.

In the preferred construction, as discussed above, cover plate 28 incorporates aperture 33 formed therein, which is aligned with the top, exposed surface of flap 31. As a result, any individual is able to provide a personalized message on flap 31, with that personalized message being viewable through aperture 33. In this way, the recipient of advertising/promotional display and holding system 20 of the present invention is able to quickly and easily understand that the contents thereof are being presented to that individual, along with any other desired information provided on flap 31, prior to actually opening holding system 20.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Having describe my invention, what I claim as new and desire to secure by the Letters Patent is:

1. An advertising/promotional display system comprising a housing constructed for being quickly and easily moved between a first folded position and a second fully erect, three-dimensional position, said housing comprising:
A. a first base panel incorporating a first side edge, a second side edge positioned adjacent the first side edge, a third side edge positioned adjacent the second side edge and parallel to the first side edge, and a fourth side edge positioned adjacent the third side edge and parallel to the second side edge;
B. a first wall member integrally affixed along a first side edge thereof to the first side edge of the base panel along a first fold line and integrally affixed along a second side edge thereof along a second fold line to a second panel, said second side edge of said wall member being parallel to the first side edge thereof and said second panel comprising an overall dimension substantially equivalent to the first base panel;
C. a second wall member integrally affixed along a first side edge thereof to the third side edge of the base panel along a third fold line and integrally affixed along a second side edge thereof along a fourth fold line to a bonding strip, said second side edge of said wall member being parallel to the first side edge thereof and said bonding strip being constructed for being securely affixed to a portion of the second panel for establishing a first, closed, hollow, foldable assembly;
D. a third wall member integrally affixed along a first side edge thereof to the second side edge of the base panel along a along a fifth fold line;
E. a fourth wall member integrally affixed along a first side edge thereof to the fourth side edge of the base panel along a sixth fold line and integrally affixed along a second side edge thereof along a seventh fold line to a third panel, said second side edge of said wall member being parallel to the first side edge thereof and said third panel comprising an overall dimension substantially equivalent to the second panel and the first base panel; and
F. a fifth wall member integrally affixed along a first side edge thereof to a side edge of the third panel along an eighth fold line, said side edge and said eighth fold line being parallel to the seventh fold line, with said fifth wall member being constructed for being securely affixed to the third wall member for establishing a second, closed, hollow foldable assembly.

2. The advertising/promotional display and holding system defined in claim 1, wherein the first, closed, foldable assembly is moved from a first, substantially flat, two-dimensional position into a second, erect, three-dimensional position by applying a first activation force along a first axis, and the second, close, foldable assembly is moved up from a first, substantially flat, two-dimensional configuration into a second, erect, three-dimensional configuration by applying a second activation force along a second axis, said first axis and said second axis being substantially perpendicular to each other.

3. The advertising/promotional display and holding system defined in claim 1, wherein the second panel is positioned to overlie the third panel when the housing is in its second, fully erect position, thereby forming the top surface of the housing.

4. The advertising/promotional display and holding system defined in claim 3, wherein said housing further comprises a pivotable cover panel integrally affixed to a second edge of the third wall member along a ninth fold line, said second edge of said wall member being parallel to the first side edge thereof and said pivotable cover panel comprising an overall dimension substantially equivalent to the second panel and the third panel, while also being constructed for arcuate pivoting movement from an open position removed from the second panel into a closed position in overlying aligned relationship with the second panel.

5. The advertising/promotional display and holding system defined in claim 4, wherein said housing is further defined as comprising a substantially rectangular shape with the first base panel, second panel, third panel, and pivotable cover panel each comprising substantially flat, rectangular shapes, with each of said panels being in overlying vertical alignment with each other when said housing is in its second, fully erect and closed position.

6. The advertising/promotional display and holding system defined in claim 4, wherein said second panel is further defined as comprising a holding tab or flap formed thereon for enabling a gift to be easily retained thereby.

7. The advertising/promotional display and holding system defined in claim 6, wherein said gift is further defined as comprising one selected from the group consisting of money cards, credit cards, gift cards, debit cards, prize cards, lottery cards, show tickets, theater tickets, and prize awards.

8. The advertising/promotional display and holding system defined in claim 7, wherein said holding tab or flap is constructed for enabling a personalized message to be placed thereon.

9. The advertising/promotional display and holding system defined in claim 8, wherein said pivotable cover panel is further defined as comprising an enlarged aperture formed therein with said aperture being aligned with the holding tab or flap of the second panel for enabling at least partial viewing of the personalized message.

10. The advertising/promotional display and holding system defined in claim 1, wherein said second panel is further defined as comprising an access panel integrally formed therewith for enabling the interior of said housing to be accessible for storage of a gift therein.

11. The advertising/promotional display and holding system defined in claim 1, wherein each of the surfaces of the panel members forming the housing are further defined as comprising surfaces on which any desired indicia is displayed for providing an exciting, interest generating, decorative visual display.

12. The advertising/promotional display and holding system defined in claim 11, wherein said indicia comprises one or more selected from the group consisting of printed matter, messages, colors, slogans, logos, graphics, alphanumeric designations, and images.

13. The advertising/promotional display and holding system defined in claim 4, wherein said seventh fold line comprises a slot formed therein and said cover comprises a tab extending from the terminating edge thereof with said tab being constructed for insertion in said slot, thereby securing the cover to the housing when in its closed position.

14. The advertising/promotional display and holding system defined in claim 13, wherein said tab comprises securing means for assuring the secured engagement of the tab in the slot.
